(19) United States
(12) Patent Application Publication
(10) Pub. No.: US 2002/0022669 A1
(43) Pub. Date: Feb. 21, 2002

(54) AQUEOUS LIQUID FOR FORMING SOAP BUBBLES

(76) Inventor: MASAAKI TOMIDA, TOKYO (JP)

Correspondence Address: Dike,Bronstein,Roberts & Cushman, Intellectual Property Practice Group, PO Box 9169, Boston, MA, 02209, US

(21) Appl. No.: 09/071,458

(22) Filed: May 1, 1998

(30) Foreign Application Priority Data
May 6, 1997 (JP) 9-131746

(51) Int. Cl. C09K 3/00

(52) U.S. Cl. 516/98

(57) ABSTRACT

An aqueous liquid for forming soap bubbles of the present invention, contains, as an emulsifier, an ester of a fatty acid having 8 to 14 carbon atoms with a polyhydric alcohol having not less than four hydroxyl groups, the percentage of esterified hydroxyl groups of said polyhydric alcohol being to 25 % based on total hydroxyl groups of the polyhydric alcohol.

Such aqueous liquid for forming soap bubbles has a high safety and is suitable for children's recreations or amusements.

### BACKGROUND OF THE INVENTION

The presert invertion relates to an aqueous liquid for forming soap bubbles, and more particularly, to an aqueous liquid for playing to form soap bubbles, which is prepared by using edible raw materials, has a high safety and is suitable for children's recreations or amusements.

With change in social environments, indoor games such as personal computer games have extensively prevailed as children's recreations. However, since such indoor recreations keep children in their roots all day long, outdoor recreations have been recentlv recommended to protect children from being adversely influenced by these indoor games. Bubble blowing play is one of most popular outdoor recreations for children. Meanwhile, as a solution for forming bubbles, there have been used a soapy water, etc., which are capable of readily forming soap bubbles upon blowing. When the soapy waer is blown upon playing, it is likely that children erroneously suck the soapy water in their mouths. However, soap has a bitter taste and, therefore, is unfavorable as a raw material co the aqeous liquid for forming soap bubbles. Further, there arises a problem that children, especially infants, tend to erroneously drinks in or swallow the soapy water upon playing.

### SUMMARY OF THE INVENTION

As a result of the present inventors' earnest studies for solving the above-mentiorned problems, it has been found that an aqueous liquid for forming soap bubbles, containing a specific ester of fatty acid with polyhydric alcohol, which is capable of forming soap bubbles upon blowing, has substantially no bitter taste and can show a high safety upon erroneously drinking. The present invention has been attained on the basis of the finding.

It is an object of the present invention to provide an aqueous lquid for forming soan bubbles showaing a high safety even when he aqueous liquid is erroneously drunk in or swallowed, did therefore, being suited for children's recreations or plays.

To accomplish the aim, in a first aspect of the present invention, there is provided an aqueous liquid for forming soap bubbles, which comprises, as an emilsifer, an ester of a fatty acid having 8 to 14 carbon atoms with a polyhydric alcohol having not less than four hydroxyl groups,

the percentage of esterfied hydroxyl groups of the polyhydric alcohol being 1 to 25 % based on total hydroxyl groups of the polyhydric alcohol.

In a second aspect of the present invention, there is provided a method of preparing an aqueous liquid for forming soap bubbles, which contains, as an emulsifier, an ester of a fatty acid having 8 to 14 carbon atoms with a polyhydric alcohol havina not less than four hydroxyl groups, wherein the percentage of esterified hydroxyl groups of said polyhydric alcohol based on total hydroxyl groups thereof is 1 to 25 % based on total hydroxyl groups of the polyhydric alcohol, for using as an aqueous liquid for forming soap bubbles.

In a third aspect of the present invention, there is provided a method of forming soap bubbles using an aqueous liquid comprising, as an emulsifier, an ester of a fatty acid having 8 to 14 carbon atoms with a polyhydric alcohol having not less than four hydroxyl groups, wherein the percentage of esterified hydroxyl groups of said polyhydric alcohol based on total hydroxyl groups thereof is 1 to 25 %, for preparing an aqueous liquid for forming soap bubbles.

### DETAILED DESCRIPTION OF THE INVENTION

The present invention will be described in detail below. in an aqueous liquid for forming soap bubbles (hereinafter referred to merely as “soap-bubbling aqueous liquid”) according to the present invention, in order to obtain an excellent bubble-forming property, there can be used an ester of a fatty acid having 8 to 14 carbon atoms with a polyhydric alcohol having not less than four hydroxvl groups, in which the percentage of esterified hydroxyl groups of the polylhydric alcohol is 1 to 5 % based on total hydroxyl groups of the polyhydric alcohol. When the number of carbon atoms of the fatty acid is less than 8 or more than 14, the obtained soap-bubbling aqueous liquid cannot exhibit a sufficient bubble-forming property.

Typical examples of the fatty acid moiety may include caprylic acid, capric acid, lauric acid, myristic acid or the like. Among them, fatty acids composed mainly of myristic acid are preferred from the viewpoint of taste. The content of myristic acid in the preferred fatty acids is preferably not less than 30 % by weight, more preferably 40 to 100 % by weight based on the weight of the fatty acids.

Typical examples of the polyhydric alcohol moiety may include sugars or sugar alcohols such as sucrose, sorbitol, glucose, fructose, maltose, raffinose, lactose, xylose, mannitol, erythritol or maltitol, sugar alcohol derivatives such as polyoxyethylene sorbitan, glycerols such as glycerol or polyglycerol, or the like. Among them, sucrose and polyglycerol are preferred. Further, as the polyglycerols, those having a polymerization degree of not less than 4 are more preferred.

The percentage of esterified hydroxyl groups of the polyhydric alcohol is usually 1 to 25 %, preferably 5 to 22 % based on total hydroxyl group of the polyhydric alcohol. When the percentage of esterified hydroxyl groups of the polyhydric alcohol is more than 25%, the obtained soap-bubbling aqueous liquid is deteriorated in bubble-forming property. Such a percentage of esterified hydroxyl groups of the polyhydric alcohol may be determined according to the following method.

That is, for example, in the case of sucrose fatty ester, there can be adopted a method of separating the ester into individual components which are different in percentage of esterified hydroxyl groups of the polyhydric alcohol from each other, by gel permeation chromatography (GPC), and calculating the percentage of esterified hydroxyl groups from peak areas of the respective components. In the gel permeation chromatography, “TSK-gel G2500HXL” produced by TOSO CO., LTD. may be used as a separation column, and tetrahydrofuran may be used as an eluent. Further, in the case of polyglycerol fatty ester, there may be adopted a method of calculating the percentage of esterified hydroxyl groups from the ratio of polyglycerol to fatty acid charged into a reactor upon reaction and the amount of residual polyglycerol after the reaction. In this case, the separation of the residual polyglycerol may be conducted, for example, by a liquid-liquid extraction method using an aqueous solution containing isobutyl alcohol and sodium sulfate.

The fatty acid esters used in the present invention are preferably selected from the emulsifer being approved as food additives.

The soap-bubbling aqueous liquid according to the present invention can be produced by dissolving the above-mentioned fatty ester as an emulsifier in water. The amount of the fatty ester used is usually 0.1 to 10 % by weight, preferably 0.5 to 5 % by weight based on the weight of the soap-bubbling aqueous liquid.

The soap-bubbling aqueous liquid according to the present invention may usually contain a thickener to impart an appropriate viscosity thereto. Especially, thickeners used as foods or food additives are more preferred. Typical examples of the thickeners may include thickened polysaccharides. Specific examples of the preferred thickeners may include microbe-yielded viscous materials such as xanthari gun, gellan gum, pullulan or curdlan; plant seed viscous materials (mucilage derived from seed) such as guar gum (guaran), locust bean gum, tamarind seed gum or tara gum; sea weed extracts such as carrageenan or agar; vegetable resin viscous materials (mucilage derived from vegetable resin) such as glim arabic, tragacanth gum or karaya gum; plant fruit viscous materials (mucilage derived from plant fruits) such as pectin or arabinogalactan; celluloses such as methyl cellulose, hydroxymethyl cellulose or hydroxypropyl cellulose; starches such as starch or modified starch; or the like. In addition, as the thickeners, there can also be used animal proteins such as gelatin, albumin or casein, and plant proteins such as soybean protein or wheat protein. These thickeners can be used singly or in the form of a mixture of any two or more thereof.

The amount of the thickener used is varied depending upon kind and aimed viscosity thereof. In the case of thickened polysaccharides, the amount of the thickener used therefor is usually 0.001 to 5 % by weight, preferably 0.01 to 0.2 % by weight based on the weight of the soap-bubbling aqueous liquid.

Further, the soap-bubbling aqueous liquid according to the present invention may contain various other additives preferably which are approved as foods or *ood additives, if required.

For exampple, the use of an ionic emulsifier such as an organic acad moncglvcerol ester or the like as the other additives can suitably enhance the solubility of the polyhydric alcohol fatty ester. The amiount of such an ionic emulsifier usec is usually 0.1 to 20 % by weight. preferably 1 to 10 % by weight based on the weicht of the polyhydric alcohol fatty ester. These emulsifiers can be used singly or a mixture thereof.

Also, the addition of sugars to the soap-bubbling aqueous liqud can impart a sweetness, can improve in its favorableness, and is useful to stabilize properties of the soap-bubbling aqueous liquid. As such sugars, there can be used saccharides or sugar alcohols. Specific examples of the saccharides may include sucrose, glucose, fructose, malose, malotriose, raffinose, lactose, xylose, galactose or the like. In addition, specific examples of the sugar alcohols may include mannitol, sorbitol, glycerol, erythritol, maltitol, lactinol or the lke. The amount of the sugars added is varied depending upon the intended product, and is usually 0.1 to 20 % by weight, preferably 0.1 to 10 % by, weight based on the weight of the soap-bubbling aqueous liquid. Further, in addition to the above-mentioned additives, the soap-bubbling aqueous liquid may appropriately contain perfumes, colorants, souring agents, preservatives, alcohols or the like.

The soap-bubbling aqueous liquid according to the present invention is less bitter taste when sucked into mouth and suitable for bubble blowing play. Further, the soap-bubbling aqueous liquid is safe even when erroneously drunk in or swallowed and capable of forming soap bubbles by blowina air thereinto.

### EXAMPLES:

The present invention will be described in more detail by examples, but these examples are not intended to limit the scope of the present invention.

Exampless 1 to 5 and Comparative Examples 1 tc 3:

Emulsiflers (polyhydric alcohol fatty esters), thickeners and sugars shown in Table 1 were respectively dissolved in distilled water to obtain soap-bubbling aqueous liquids having compositions shown ir mabie 2. The thus obtained. soap-bubbling aqueous liquids were evaluated with respect to bubble-forming property and low-temperature fludity thereof according to the following methods (1) and (2). The results are shown in Table 2.

(1) Bubble-Forming Property:

A straw having a ring at its tip end was dipped in the soap-bubbling aqueous liquid, thereby applying the solution to the tip end portion thereof. Air was blown into the straw from its opposite end to form soap bubbles. The soap bubbles were observed to evaluate a bubble-forming property of the soap-bubbling aqueous liquids. The evaluation is as follows:

O: Bubbles were readily formed and maintained for a sufficient period of time.

X: Bubbles were broker immediately, or no bubbles were formed.

(2) Low-Temperature Fluidity:

The soap-bubbling aqueous liquid was allowed to stand at 10° C. for one day. Thereafter, the soap-bubbling aqueous liquid was evauated with respect to fluidity and uniformity thereof. The evaluation is as follows:

◯: The solution was kept uniform and transparent and exhibited a good fluidity.

Δ: The solution was uniform and transparent, but deteriorated in fluidity.

X: The solution was turbid or precipitated, or exhibited no fluidity.

TABLE 1

| | Emulsifier | | | | | | |
|---|---|---|---|---|---|---|---|
| | | | | Percentage of | | | |
| Examples | | | | esterified hydroxyl | | | |
| and | | | | groups of | | | |
| Comparative | | Fatty acid in | | polyhydric alcohol | Thickener | | Sugars |
| Examples | Kind | one molecule | | (%) | Kind | | Kind |
| Example 1 | Sucrose | Myristic | acid | 15 | Xanthan | gum | Glycerol |
| | fatty ester | | | | | | |
| Example 2 | Sucrose | Lauric | acid | 15 | Guar | gum | Starch syrup |
| | fatty ester | | | | | | |
| Example 3 | Sucrose | Caprylic | acid | 14 | λ Carrageenan | | Glucose |
| | fatty ester | | | | | | |
| Example 4 | Decaglycerol | Lauric | acid | 21 | Locust bean | gum | Sorbitol |
| | fatty ester | | | | | | |
| Example 5 | Sucrose | Myristic | acid | 13 | Xanthan gum/guar gum | | Sucrose |
| | fatty ester | | | | | | |
| Example 6 | Decaglycerol | Myristic | acid | 19 | Xanthan gum/guar gum | | Sucrose |
| | fatty ester | | | | | | |
| Comparative | Monoglycerol | Stearic | acid | 33 | Xanthan | gum | Starch syrup |
| Example 1 | fatty ester | | | | | | |
| Comparative | Sucrose | Palmitic | acid | 15 | Guar | gum | Glucose |
| Example 2 | fatty ester | | | | | | |
| Comparative | Decaglycerol | Stearic | acid | 18 | Locust bean | gum | Sucrose |
| Example 3 | fatty ester | | | | | | |
| Comparative | Sucrose | Lauric | acid | 30 | Guar | gum | Starch syrup |
| Example 4 | fatty ester | | | | | | |

TABLE 2

| Examples | | | | Evaluation results | |
|---|---|---|---|---|---|
| and | | | | Bubble- | Low- |
| Comparative | Amount added (% by weight) | | | forming | temperature |
| Examples | Emulsifier | Thickener | Sugars | property | fluidity |
| Example 1 | 2 | 0.04 | 8 | ◯ | Δ |
| Example 2 | 2 | 0.01 | 4 | ◯ | ◯ |
| Example 3 | 2 | 0.2 | 3 | ◯ | ◯ |
| Example 4 | 2 | 0.02 | 3 | ◯ | ◯ |
| Example 5 | 2 | 0.02/0.01 | 5 | ◯ | ◯ |
| Example 6 | 2 | 0.02/0.01 | 5 | ◯ | ◯ |
| Comparative | 2 | 0.04 | 4 | X | X |
| Example 1 | | | | | |
| Comparative | 2 | 0.01 | 3 | X | X |
| Example 2 | | | | | |
| Comparative | 2 | 0.2 | 5 | X | X |
| Example 3 | | | | | |
| Comparative | 2 | 0.01 | 4 | X | X |
| Example 4 | | | | | |

What is claimed is:

1. An aqueous liquid for Lorming soap bubbles, containing, as an emulsifier, an ester of a fatty acid having 8 to 14 carbon atoms with a polyhydric alcohol having not less than four hydroxyl groups,
the percentage of esterified hydroxyl groups of said polyhydric alcohol being 1 to 25 % based on total hydroxyl groups of the polyhydric alcohol.

2. An aqueous liquid according to claim 1, wherein said fatty acid is at least one selected from the group consisting of caprylic acid, capric acid, lauric acid and myristic acid, and said polyhydric alcohol is at least ones selected from the group consisting of sugars, sugar alcohols, sugar alcohol derivatives and glycerols.

3. An aqueous liquid according to claim 1, wherein said ester is sucrose fatty ester or polyglycerol fatty ester.

4. An aqueous liquid according to claim 1, wherein the content of said ester is 0.1 to 10 % by weight based on the weight of said aqueous liquid.

5. An aqueous liquid according to claim 1, which further contains a thickener.

6. An aqueous liquid according to claim 6, wherein said thickener is polysaccharides.

7. An aqueous liquid according to claim 6, wherein said polysaccharides are at least ones selected from the group consisting of microbe-yielded viscous materials, plant seed viscous materials, sea weed extracts, vegetable resin viscous materials, plant fruit viscous materials, celluloses and starches.

8. An aqueous liquid according to claim 6, wherein the content of said polysaccharides is 0.001 to 5 % by weight based on the weight of said aqueous liquid.

9. An aqueous liquid according to claim 1, which further contains an ionic emulsifier.

10. An aqueous liquid according to claim 9, werein the amount of said ionic emulsifier is 0.1 to 2 % by weight based on the weight of said ester.

11. An aqueous liquid according to claim 1, which further comprises sugars.

12. An aqueous liquid according to claim 11 wherein said sugars are saccharides or sugar alcohols.

13. An aqueous liquid according to claim 11, wherein the content of said sugars is 0.1 to 20 % by weight based on the weight of said aqueous liquid.

14. An aqueous liquid according to claim 1, wherein said ester is one selected from the group consisting of sucrose myristate, sucrose laurate, sucrose caprylate, decaglycerol laurate and decaglycerol myristate; said thickener is selected from the group consisting of xanthan gum, guar gum, carrageenan, locust bean gum and a mixture of guar gum and xanthan gum; and said sugars are ones selected from the group consisting of glycerol, starch syrup, glucose, sorbitol and sucrose.

15. A method of preparing an aqueous liquid for forming soap bubbles, which comprises dissolving an ester of a fatty acid having 8 to 14 carbon atoms with a polyhydric alcohol having not less tnan four hydroxyl groups, wherein the percentage of esterified hydroxyl groups of said polyhydric alcohol based on total hydroxyl groups thereof is 1 to 25 based on total hydroxyl groups of the polyhydric alcohol in water.

16. A method of forming soap bubbles using an aqueous liquid comprising an emulsifier, which is an ester of a fatty acid having 8 to 14 carbon atoms with a polyhydric alcohol having not less than four hydrcxyl groups, wherein the percentage of esterified hydroxyl groups of said polyhydric alcohol based on total hydroxyl groups thereof is 1 to 25 %, for preparing an aqueous liquid for forming soap.
